(19) United States
(12) Patent Application Publication
(10) Pub. No.: US 2026/0001151 A1
(43) Pub. Date: Jan. 1, 2026

(54) SAW BLADE AND METHOD OF MANUFACTURING SAME

(71) Applicant: MILWAUKEE ELECTRIC TOOL CORPORATION, Brookfield, WI (US)

(72) Inventors: Flevian J. Gonsalves, New Berlin, WI (US); Vaibhav W. Mohadikar, Wauwatosa, WI (US); David Hlavac, Colgate, WI (US)

(21) Appl. No.: 19/250,942

(22) Filed: Jun. 26, 2025

Related U.S. Application Data
(60) Provisional application No. 63/665,638, filed on Jun. 28, 2024.

(51) Int. Cl. B23D 61/00; B23D 61/14; B23D 65/00; B23K 11/00

(52) U.S. Cl. CPC B23D 61/006; B23D 65/00; B23K 11/0046; B23D 61/14

(57) ABSTRACT

A blade includes a body having a cutting portion with an edge and a plurality of cutting teeth sequentially aligned along the edge. Each cutting tooth of the plurality of cutting teeth is formed from a corresponding one of a plurality of carbide inserts that is discretely resistance welded to the edge. The body includes at least 15 teeth per inch.

### CROSS-REFERENCE TO RELATED APPLICATIONS

The present application claims priority to U.S. Provisional Patent Application No. 63/665,638, filed Jun. 28, 2024, the entire contents of which are incorporated herein by reference.

### BACKGROUND

The present disclosure relates to a blade for cutting a workpiece and, more specifically, to a blade for power tools.

### SUMMARY

In one embodiment, the disclosure provides a blade including a body. The body includes a cutting portion having an edge and a plurality of cutting teeth sequentially aligned along the edge. Each cutting tooth of the plurality of cutting teeth is formed from a corresponding one of a plurality of carbide inserts that is discretely resistance welded to the edge. The body includes at least 15 teeth per inch.

In another embodiment, the disclosure provides a method of manufacturing a blade. The method includes providing a blank saw blade body that includes a proximal edge that is configured for attachment to a power tool and a distal edge opposite from the proximal edge. The method further includes resistance welding a plurality of carbide inserts to the distal edge of the blank saw blade body. Moreover, the method includes forming each of the carbide inserts into a cutting tooth after the plurality of carbide inserts have been resistance welded to the distal edge of the blank saw blade body such that the blank saw blade body has at least 15 teeth per inch.

### BRIEF DESCRIPTION OF THE DRAWINGS

FIG. 1 is a side view of a power tool for receiving a blade according to an embodiment of the disclosure.

FIG. 2 is a side view cross-section of a portion of the power tool of FIG. 1 taken along line 2-2 in FIG. 1.

FIG. 3 is a top view of a blade according to an embodiment of the disclosure.

FIG. 4 is a side view of the blade of FIG. 3.

FIG. 5A is a top view of a portion of the blade of FIG. 3.

FIG. 5B is a detail view of callout 5B-5B in FIG. 5A.

FIG. 6 is a perspective view of a cylindrical carbide blank.

FIG. 7 is a top view of a blade according to another embodiment of the disclosure.

FIG. 8 is a side view of the blade of FIG. 7.

FIG. 9A is a top view of a portion of the blade of FIG. 7.

FIG. 9B is a detail view of callout 9B-9B in FIG. 9A.

FIG. 10 is a schematic flow diagram illustrating a method of manufacturing the blade of FIG. 3 and/or the blade of FIG. 7.

FIG. 11 is a top view of a blank saw blade body.

FIG. 12A is a top view of the blank saw blade body of FIG. 11 including tooth bodies formed along an edge of the blank saw blade body according to one embodiment of the disclosure.

FIG. 12B is a detail view of callout 12B-12B in FIG. 12A.

FIG. 13A is a top view of the blank saw blade body of FIG. 11 including tooth bodies formed along an edge of the blank saw blade body according to another embodiment of the disclosure.

FIG. 13B is a detail view of callout 13B-13B in FIG. 13A.

FIG. 14A is a top view of a resistance welding machine used for attaching a carbide insert to the tooth bodies of FIG. 12A.

FIG. 14B is a detail view of the carbide insert and the tooth bodies of FIG. 14A at a point of attachment for the carbide insert and the tooth bodies.

FIG. 14C is a top view of an electrode configured to receive the carbide insert of FIG. 14A for attachment to a respective tooth body.

FIG. 14D is an enlarged top view of the resistance welding machine of FIG. 14A, prior to attachment of the carbide insert to a respective tooth body.

FIG. 15 is a top view of a plurality of the blades of FIG. 3.

FIG. 16A is a detail view of an edge of a blade including tooth bodies according to another embodiment of the disclosure.

FIG. 16B is a detail view of the edge of the blade of FIG. 16A with carbide inserts attached to the tooth bodies.

FIG. 16C is a detail view of the edge of the blade in which the carbide inserts of FIG. 16B have been formed into cutting tips.

FIG. 16D is a front view of an electrode configured to receive a carbide insert for attachment to the blade of FIG. 16A.

FIG. 16E is a top view of a resistance welding machine for attaching a carbide insert to the blade of FIG. 16A.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

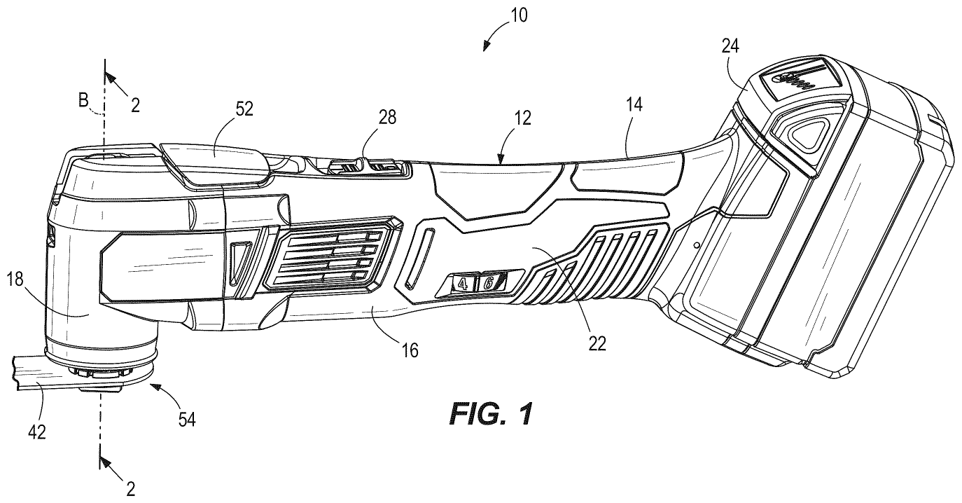

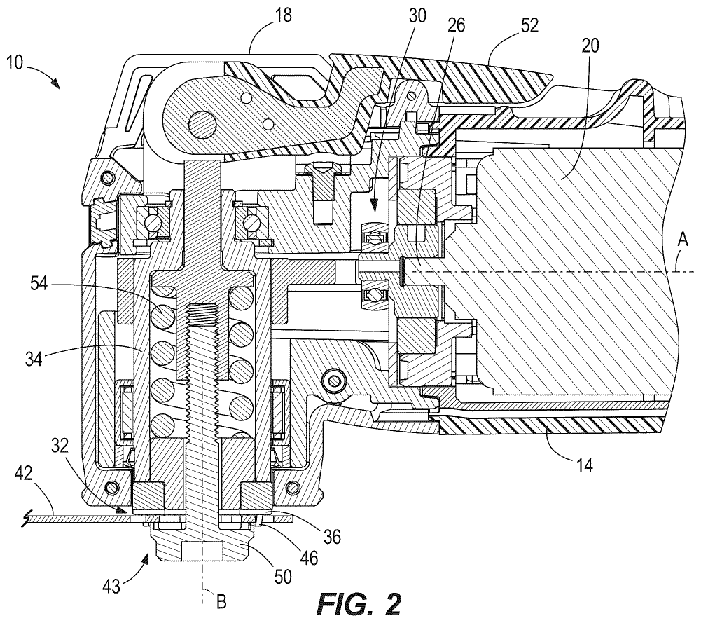

FIG. 1 illustrates a power tool 10 according to one embodiment of the disclosure. In the illustrated embodiment, the power tool 10 is an oscillating multi-tool (OMT). The power tool 10 includes a main body 12 having a housing 14 defining a handle 16 and a head 18. The head 18 is driven by a motor 20 (FIG. 2) disposed within the housing 14. The handle 16 includes a grip portion 22 providing a surface suitable for grasping by an operator to operate the power tool 10. The housing 14 generally encloses the motor 20.

The motor 20 in the illustrated embodiment is an electric motor driven by a power source such as a battery pack 24 (FIG. 1), but may be powered by other power sources such as an AC power cord in other embodiments. In yet other embodiments, the power tool 10 may be pneumatically powered or powered by any other suitable power source and the motor 20 may be a pneumatic motor or other suitable type of motor. The motor 20 includes a motor drive shaft 26 (FIG. 2) extending therefrom and driven for rotation about a motor axis A. The motor 20 may be a variable speed or multi-speed motor. In other embodiments, other suitable motors may be employed.

The battery pack 24 (FIG. 1) is a removable and rechargeable battery pack. In the illustrated embodiment, the battery pack 24 may include a 12-volt battery pack, a 14.4-volt battery pack, an 18-volt battery pack, or any other suitable voltage, and includes Lithium-ion battery cells (not shown). Additionally or alternatively, the battery cells may have chemistries other than Lithium-ion such as, for example, Nickel Cadmium, Nickel Metal-Hydride, or the like. In other embodiments, other suitable batteries and battery packs may be employed, or the power tool 10 may be corded or pneumatically powered.

The main body 12 also includes a power actuator 28 (FIG. 1). The power actuator 28 is movably coupled with the housing 14 and is actuatable to power the motor 20, e.g., to electrically couple the battery pack 24 and the motor 20 to run the motor 20. The power actuator 28 may be a sliding actuator as shown, or in other embodiments may include a trigger-style actuator, a button, a lever, a knob, etc.

The housing 14 also houses a drive mechanism 30 (FIG. 2) for converting rotary motion of the motor drive shaft 26 into rotary oscillating motion of an output mechanism 32. In other embodiments, the drive mechanism 30 may convert rotary motion of the motor drive shaft 26 into rotary motion of the output mechanism 32, linear reciprocating motion of the output mechanism 32, or any other suitable motion conversion and/or transmission gear reduction. As shown in FIG. 2, the output mechanism 32 includes a spindle 34 having an accessory holder 36 disposed at a distal end thereof. The spindle 34 terminates, at a free end, with the accessory holder 36. The accessory holder 36 is configured to receive an accessory, such as a blade 42, and a clamping mechanism 43 (FIG. 2) clamps the blade 42 to the accessory holder 36. The clamping mechanism 43 may include any suitable clamp for holding the blade 42 to the accessory holder 36, e.g., as are known for oscillating saws (as illustrated), as well as other saws, such as reciprocating saws, circular saws, band saws, etc. As illustrated, the accessory holder 36 includes a first locating feature 46, such as a protrusion or protrusions sized and shaped for receiving the blade 42. The clamping mechanism 43 includes a clamping flange 50 at a distal end thereof for clamping the blade 42 to the accessory holder 36 for oscillating motion with the spindle 34. A clamping actuator 52, such as a lever, is configured to apply and release a clamping force from a biasing member 54, such as a spring. The spindle 34 defines an oscillation axis B, substantially perpendicular to the motor axis A, about which the spindle 34 oscillates. In other embodiments, other clamping actuators may be employed, such as a button, a knob, etc.

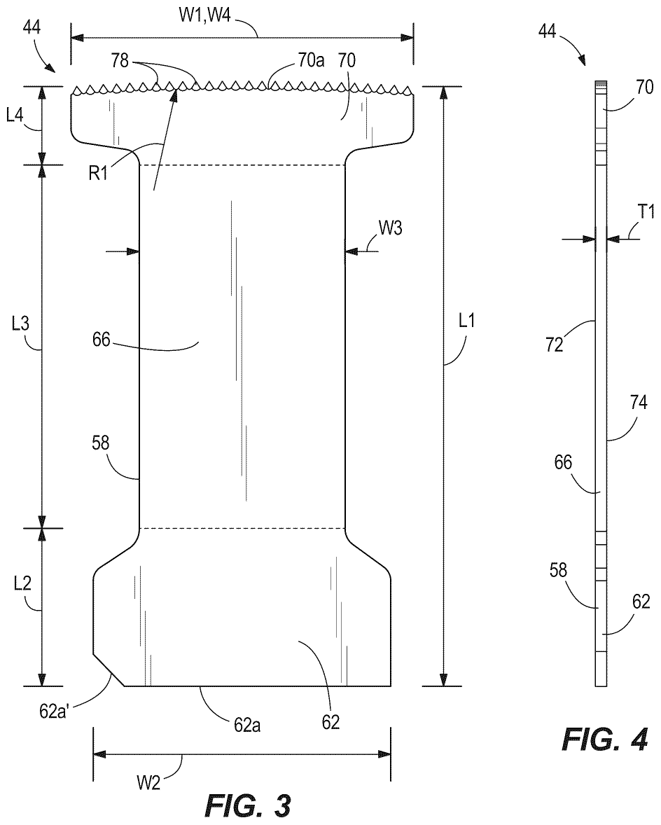

FIGS. 3-5B illustrate a blade 44 according to one embodiment of the disclosure. In the illustrated embodiment, the blade 44 is an oscillating multi-tool (OMT) blade for use with the power tool 10 (OMT) of FIGS. 1-2. With reference to FIGS. 3 and 4, the blade 44 includes a body 58 preferably formed from metal, which may include a metal, a metal alloy, a bi-metal, or any combination of metals, metal alloys, bi-metals, etc. The body 58 may be formed from other materials in other embodiments. In some embodiments, the body 58 may be preferably formed from a non-carbide material. The body 58 includes a total length L1, a maximum width W1, and a thickness T1 defined between two substantially planar blade body surfaces 72, 74. The total length L1 may between about 1.5 inches and about 10 inches. More specifically, the total length L1 is between about 2 inches and about 3 inches. In the illustrated embodiment, the total length L1 is about 2.42 inches. The maximum width W1 may between about 0.5 inches and about 3 inches. More specifically, the maximum width is between about 1 inch and about 2 inches. In the illustrated embodiment, the maximum width W1 is about 1.375 inches. A ratio of the total length L1 to the maximum width W1 may be between 1 and 3. More specifically, the ratio of the total length L1 to the maximum width W1 may be between 1.5 and 2. In the illustrated embodiment, the ratio of the total length L1 to the maximum width W1 is 1.76. The thickness T1 may between about 0.02 inches and about 0.06 inches. More specifically, the thickness T1 is between about 0.035 inches and about 0.045 inches. In the illustrated embodiment, the thickness T1 is about 0.042 inches.

The body 58 includes an attachment portion 62 that defines a proximal edge 62a, an extension portion 66, and a cutting portion 70 that defines a distal edge 70a. In the illustrated embodiment, the attachment portion 62, the extension portion 66, and the cutting portion 70 each have the thickness T1 and are oriented co-planar with one another. In some embodiments, the attachment portion 62, the extension portion 66, and the cutting portion 70 may have different thicknesses. In other embodiments, one or multiple of the attachment portion 62, the extension portion 66, and the cutting portion 70 may not be co-planar such that at least one of the portions is offset from the other of the portions. The attachment portion 62 is configured to be attached to the power tool 10 (FIG. 1) to couple the blade 44 to the power tool 10. The extension portion 66 extends between the attachment portion 62 and the cutting portion 70. The cutting portion 70 is configured to engage a workpiece to perform a cutting action.

In the illustrated embodiment, the attachment portion 62 is formed in a roughly trapezoidal shape. In other embodiments, the attachment portion 62 may be formed in other shapes, such as a circular or a rectangle. The attachment portion 62 may include coupling features to facilitate coupling with the power tool 10 of FIG. 1. The attachment portion 62 has a first width W2 and a first length L2. In the illustrated embodiment, the first width W2 is smaller than the maximum width W1. Specifically, the first width W2 may between about 0.025 inches and about 2.5 inches. More specifically, the first width W2 is between about 1 inch and about 1.5 inches. In the illustrated embodiment, the first width W2 is about 1.2 inches. In other embodiments, the first width W2 may be the same as the maximum width W2 of the blade 44 such that the first width W2 defines the maximum width W1. The proximal edge 62a of the attachment extends linearly along a width direction. The width direction is the direction that the measurement of the maximum width W1 of the blade 42 extends along. A cutout 62a′ is formed at a corner of the proximal edge 62a. The cutout 62a′ extends at a 45-degree angle relative to the proximal edge 62a to an edge of the attachment portion 62 extending along a length direction. The length direction is the direction that the measurement of the total length L1 of the blade 42 extends along. In some embodiments, the proximal edge 62a may be curved. Edges of the attachment portion 62 that extend along the length direction define the width W2 of the attachment portion 62 and curve inwardly to the extension portion 66 at an end of the length L2 opposite from the proximal edge 62a. In some embodiments, the edges may extend linearly inward to the extension portion 66 at the end of the length L2 opposite from the proximal edge 62a.

In the illustrated embodiment, the extension portion 66 is rectangular and extends from the attachment portion 62 to the cutting portion 70. The extension portion 66 has a second width W3 and a second length L3. In the illustrated embodiment, the second width W3 is smaller than the first width W2. Specifically, the second width W3 may be between about 0.2 inches and about 0.6 inches. More specifically, the second width W3 is between about 0.35 inches and about 0.5 inches. In the illustrated embodiment, the second width W3 is about 0.413 inches. In some embodiments, the second width W3 may be the same as or greater than the first width W2. The extension portion 66 is optimally sized to give the blade 44 a longer total length L1 than conventional blades. That is, for example, the width W3 of the extension portion 66 may be optimally sized to increase the distance between the attachment portion 62 and the cutting portion 70, thus increasing the reach of the blade 44. Accordingly, the extension portion 66 forms a majority of the total length L1 such that the second length L3 is at least half of the total length L1 in the illustrated embodiment. In some embodiments, the second length L3 may be at least two-thirds of the total length L1. In further embodiments, the second length L3 may be at least three-quarters of the total length L1.

In the illustrated embodiment, the cutting portion 70 is formed in a roughly rectangular shape. In other embodiments, the cutting portion 70 may be formed in other shapes. The cutting portion 70 has a third width W4 and a third length L4. In the illustrated embodiment, the third width W4 is greater, or larger, than the first width W2 and defines the maximum width W1 of the blade 44. The shapes and sizes of the attachment portion 62, the extension portion 66, and the cutting portion 70 give the blade 44 a dog-bone shape. The distal edge 70a of the cutting portion 70 is configured to engage a workpiece for performing the cutting action. In the illustrated embodiment, the distal edge 70a is non-linear. That is, the distal edge 70a is curved and has a radius of curvature R1 between 8 inches and 14 inches. In some embodiments, the radius of curvature R1 may be between 10 and 12 inches. In the illustrated embodiment, the radius of curvature R1 is preferably 11.14 inches. In further embodiments, the distal edge 70a may be linear, or flat.

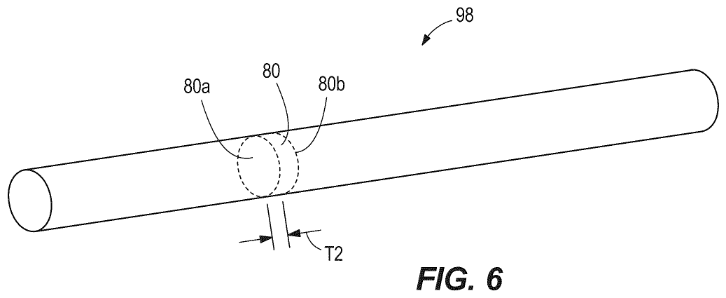

A plurality of cutting tips or cutting teeth 78 are attached to the cutting portion 70 along the distal edge 70a. The cutting tips 78 may be aligned sequentially, one after another, along the curvature of the distal edge 70a and on a common plane. In the illustrated embodiment, the cutting tips 78 are attached to the body 58 through resistance welding. In other embodiments, the cutting tips 78 may be attached to the body 58 through other means, such as brazing or fastening. Each of the cutting tips 78 is initially provided as an individual unitary piece formed from a carbide insert 80 having the shape of a circular disc (e.g., as illustrated in FIG. 6). The carbide inserts 80 (FIG. 6) are then further ground down, cut, and/or shaped into the cutting tips 78 after the cutting inserts 80 are attached to the body 58, as will be described in greater detail below. Each of the cutting tips 78 includes at least some carbide. For example, the cutting tips 78 may be formed entirely from carbide, may be coated or plated in carbide, or may include carbide therein in any other suitable fashion. Carbide is a compound including carbon and at least one other ingredient, such as one or more metals, one or more metal oxides, and/or one or more semi-metallic elements. For example, the cutting tips 78 may include H12F, H15F, DH40, titanium carbide, tungsten carbide, vanadium carbide, boron carbide, silicon carbide, etc., or any combination thereof. The cutting tips 78 may all include the same type of carbide, or some of the cutting tips 78 may be formed from different carbides than the others. The cutting tips 78 may each be formed from more than one type of carbide, in any combination, and may be formed from only carbide or from a combination of carbide and a non-carbide.

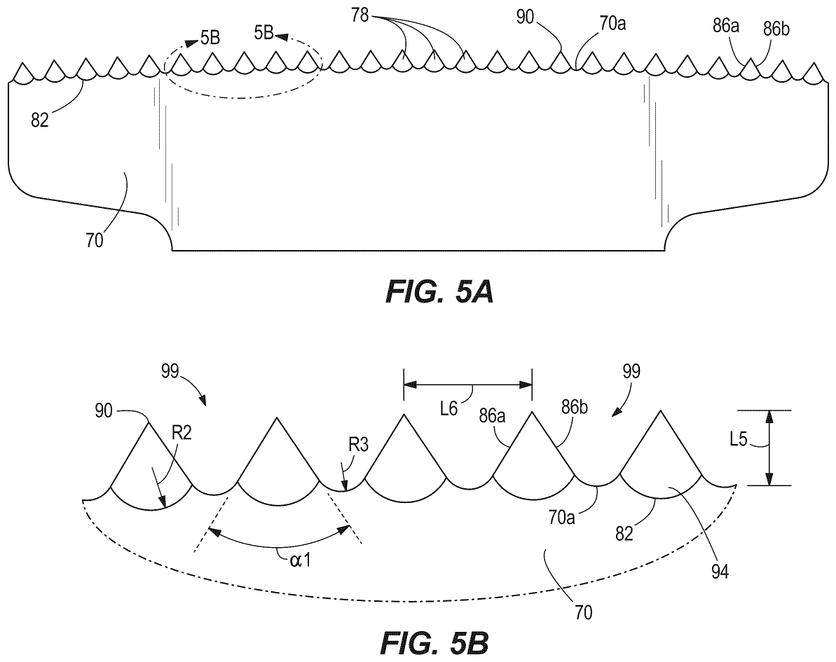

With reference to FIGS. 5A and 5B, the cutting tips 78 may have a pie shape and extend perpendicularly from the distal edge 70a at a point of contact between each cutting tip 78 and the distal edge 70a. The pie shape is defined as having a generally curved edge 82 and two generally straight edges 86a, 86b each extending from the generally curved edge 82 and meeting at an apex or tip 90. The cutting tips 78 may additionally include a root 94 that is rooted in the body 58 of the blade 44. The generally curved edge 82 of the cutting tips 78 may include any suitable curve, such as an arch, an arc, any other convex curve, a concave curve, or any combination of the above curves. For example, the curved edge 82 may have a radius of curvature R2 from 0.025 inches to 0.055 inches, more specifically from 0.035 inches to 0.045 inches, even more specifically of about 0.039 inches (+/−0.005 inches). The radius of curvature R2 of the cutting tips 78 may be the same as the radius of the circular carbide inserts 80 that is initially attached to the body 58 (FIG. 6). Alternatively, the radius of curvature R2 of the curved edge 82 of the cutting tips 78 may have a value that is between the radius and the diameter of the circular carbide insert 80 (FIG. 6). The two generally straight edges 86a, 86b need not be perfectly straight but are mostly straight, approximately straight, follow a straight path but may stray slightly from the straight path, or are straight. The two generally straight edges 86a, 86b may define an included angle α1 with respect to each other from 15 to 90 degrees, more specifically from 30 to 85 degrees, more specifically from 50 to 80 degrees, more specifically from 60 to 80 degrees, e.g., about 65 degrees (+/−3 degrees), or about 65 degrees or less. The two generally straight edges 86a, 86b may meet at the tip 90, which may be pointed (as illustrated) or rounded.

Each of the cutting tips 78 has a first length L5 defined between the distal edge 70a of the cutting portion 70 and the tip 90. The first length L5 is between about 0.02 inches and about 0.04 inches. More specifically, the first length L5 is between about 0.025 inches and about 0.035 inches. In the illustrated embodiment, the length L5 is about 0.032 inches. A second length L6 is defined as the distance between adjacent cutting tips 78. The second length L6 may also be referred to as a pitch. The second length L6 may be measured along a direction that is substantially perpendicular to the length direction. The second length L6 is between about 0.04 inches and about 0.06 inches. More specifically, the second length L6 is between about 0.045 inches and about 0.055 inches. In the illustrated embodiment, the second length L6 is about 0.053 inches. “About” means within a tolerance of +/−0.002 inches for the first length L5 and the second length L6.

In some embodiments, the blade 44 has 25 teeth per inch (TPI) or less. In the illustrated embodiment, the blade 44 has 18 TPI. In other embodiments, the blade 44 may have between 2 and 25 TPI, or between 5 and 22 TPI, or between 7 and 20 TPI, or between 9 and 20 TPI, or between 11 and 20 TPI, or between 13 and 20 TPI, or between 14 and 18 TPI, or between 15 and 17 TPI, etc. In further embodiments, the blade 44 has at least 15 TPI. The size of each cutting tip 78 is determined according to the desired TPI. In the illustrated embodiment, each of the cutting tips 78 has the same size as the others; however, in other embodiments, some of the cutting tips 78 may be sized differently than others.

The shape and size of the cutting tips 78 illustrated herein is not to be regarded as limiting. The cutting tips 78 may have any suitable shape in other embodiments, such as circular, triangular, polygonal, elliptical, oval, cylindrical, tubular, bar-shaped, irregular, etc., or any combination of the shapes described herein, or any other suitable shape. In the illustrated embodiment, each of the cutting tips 78 has the same shape as the others; however, in other embodiments, some of the cutting tips 78 may be shaped differently than others.

With reference to FIGS. 5B and 6, the carbide inserts 80 may be formed from a cylindrical blank 98. For example, the carbide inserts 80 may be cut from the cylindrical blank 98 into circular discs having a thickness T2 and a diameter of about 0.039 inches. The carbide inserts 80 may then be machined (e.g., ground and/or cut, or any other suitable machining technique or combination thereof) into the pie shape of the cutting tips 78 illustrated herein or machined into any other suitable shape. In the illustrated embodiment, the cutting tips 78 are attached to the body 58 as the circular discs and then machined into the pie shape, or any other suitable shape, illustrated herein after attachment occurs. In some embodiments, the cutting tips 78 may be machined into the pie shape prior to attaching the cutting tips 78 to the body 58. In other embodiments, the cutting tips 78 may be formed in any suitable fashion, such as but not limited to machined from a bar, a blank, or any other type of stock, punched from a sheet, formed from any other suitable carbide blank, forged, sintered, cemented, molded, machined, cast, etc., or any other metallurgy technique. It is understood that the cutting tips 78 and the carbide inserts 80 are the same piece of carbide but simply have different shapes due to the machining process.

The thickness T2 may be measured between opposite generally planar surfaces 80a, 80b of the carbide insert 80. The thickness T2 may be between about 0.03 inches and about 0.05 inches. More specifically, the thickness T2 is between about 0.035 inches and about 0.045 inches, and even more specifically, the thickness T2 is about 0.042 inches. “About” means within a tolerance of +/−0.001 inches for the thickness T2. In the illustrated embodiment, machining the carbide insert 80 into the cutting tip 78 does not alter the thickness of the piece of carbide such that the cutting tip 78 has the thickness T2. Additionally, the thickness T2 of the cutting tip 78 and the cutting insert 80 is the same as the thickness T1 of the body 58 of the blade 44 (FIG. 4). In some embodiments, the cutting tip 78 may have a smaller thickness than the thickness T2 of the carbide insert 80. In further embodiments, one or both of the cutting tip 78 and the cutting insert 80 may have a thickness that is smaller or larger than the thickness T1 of the body 58 of the blade 44.

Returning reference to FIG. 5B, a plurality of gullets 99 is defined by the distal edge 70a of the cutting portion 70 between adjacent cutting tips 78 and provide spatial separation between adjacent cutting tips 78. The gullets 99 have a radius of curvature R3 that may be between 0.0005 inches and 0.02 inches. More specifically, the radius of curvature R3 is between about 0.005 inches and 0.015 inches. In the illustrated embodiment, the radius of curvature R3 is 0.0116 inches. The radius R3 is dependent on a size of the cutting tips 78. That is, if relatively larger cutting tips 78 are utilized (e.g., if the included angle α1 is increased), the radius R3 of the gullets 99 may be relatively smaller. Alternatively, if relatively smaller cutting tips 78 are utilized (e.g., if the included angle α1 is decreased), the radius R3 of the gullets 99 may be relatively larger.

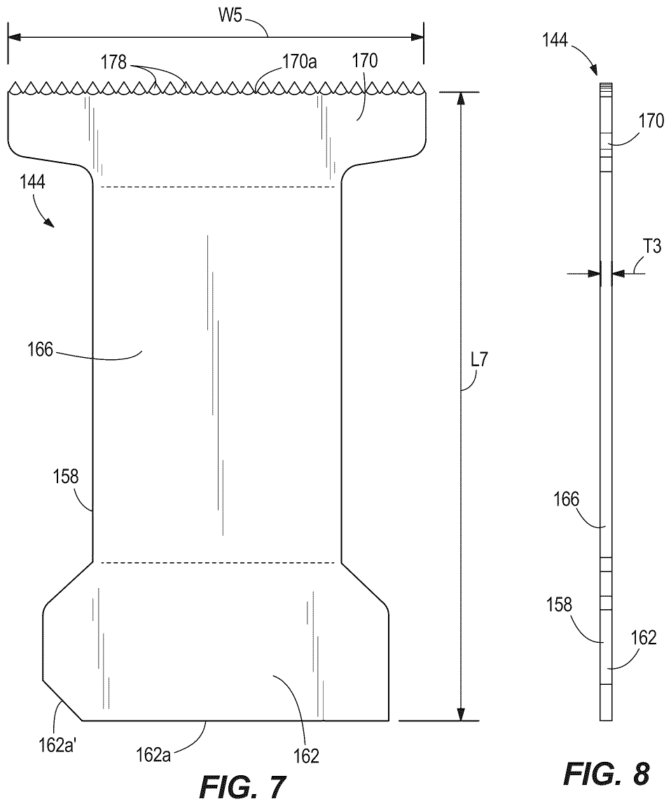

FIGS. 7 and 8 illustrate a blade 144 according to another embodiment of the disclosure. In the illustrated embodiment, the blade 144 is an OMT blade for use with the power tool 10 (OMT) of FIGS. 1 and 2. The blade 144 is substantially similar to the blade 44 of FIGS. 3 and 4, except for the differences described herein. With reference to FIGS. 7 and 8, the blade 144 includes a body 158 having a total length L7, a maximum width W5, and a thickness T3. The body 158 includes an attachment portion 162, an extension portion 166, and a cutting portion 170. Although not described here in detail, the attachment portion 162, the extension portion 166, and the cutting portion 170 may each have widths, lengths, and thicknesses that are similar to or the same as the widths W2, W3, W4, lengths L2, L3, L4, and thicknesses T1 described with respect to a corresponding one of the attachment portion 62, the extension portion 66, and the cutting portion 70 of the blade 44 of FIGS. 3 and 4. As illustrate in FIG. 7, the attachment portion 162 includes a proximal edge 162a having a cutout 162a′.

In the illustrated embodiment, the cutting portion 170 is formed in a roughly rectangular shape. In other embodiments, the cutting portion may be formed in another shape. The cutting portion 170 includes a distal edge 170a that is linear. That is, the distal edge 170a is parallel to the proximal edge 162a of the attachment portion 162. Stated another way, the distal edge 170a is perpendicular to a length direction of the blade 144. A plurality of cutting tips 178 are disposed along the distal edge 170a and are aligned sequentially, one after another, in a linear fashion and on a common plane.

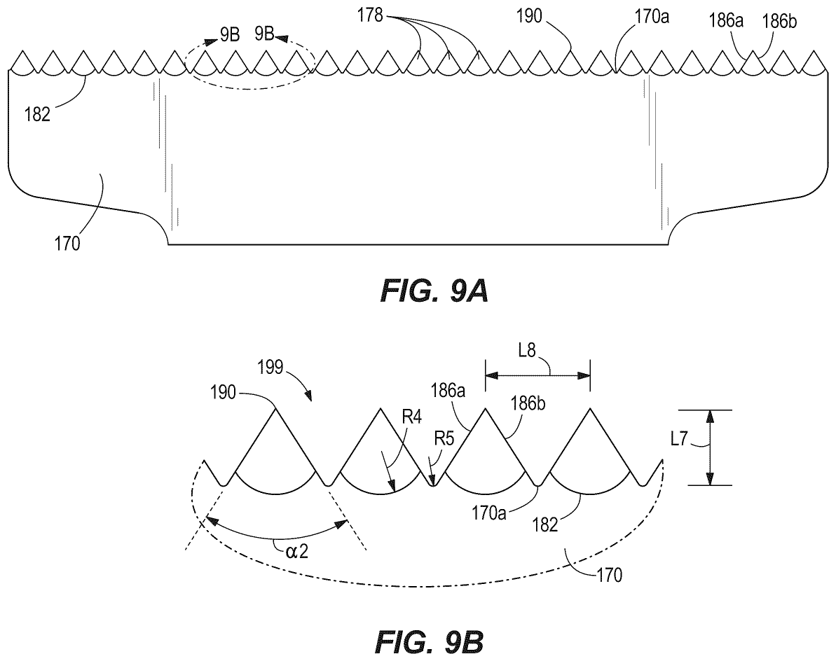

With reference to FIGS. 9A and 9B, the cutting tips 178 are shaped, formed, and attached to the body 158 in a similar fashion as the cutting tips 78 of FIG. 5B. Accordingly, the cutting tips 178 may have a pie shape, which is defined as having a generally curved edge 182 and two generally straight edges 186a, 186b each extending from the generally curved edge 182 and meeting at the tip 190. The generally curved edge 182 includes a radius of curvature R4 that may be substantially similar to the radius R2 of the generally curved edge 82 of FIG. 5B. The two generally straight 186a, 186b may define an included angle α2 that is substantially similar to the included angle α1 of FIG. 5B. The cutting tips 178 may also have a first length L7 and a second length L8 that are substantially similar to the first length L5 and the second length L6 of FIG. 5B, respectively. “Substantially similar” means within a tolerance of +/−3 degrees for the included angle α2 (relative to the included angle α1 of FIG. 5B) and within a tolerance of +/−0.002 inches for the radius of curvature R4, the first length L7, and the second length L8 (relative to a respective one of the radius of curvature R2, the first length L5, and the second length L6 of FIG. 5B). The cutting tips 178 may have minor dimensional differences relative to the cutting tips 78 of FIG. 5B to account for the different orientations of the linear distal edge 170a and the curved distal edge 70a. Additionally or alternatively, the dimensional differences between the cutting tips may exist for other reasons, such as functional and/or performance benefits.

A plurality of gullets 199 is defined by the distal edge 170a of the cutting portion 170 between adjacent cutting tips 178 and provides spatial separation between adjacent cutting tips 178. The gullets 199 have a radius of curvature R5 that may be between 0.0005 inches and 0.02 inches. More specifically, the radius of curvature R5 is between about 0.001 inches and 0.005 inches. In the illustrated embodiment, the radius of curvature R5 of the gullets 199 is 0.0023 inches.

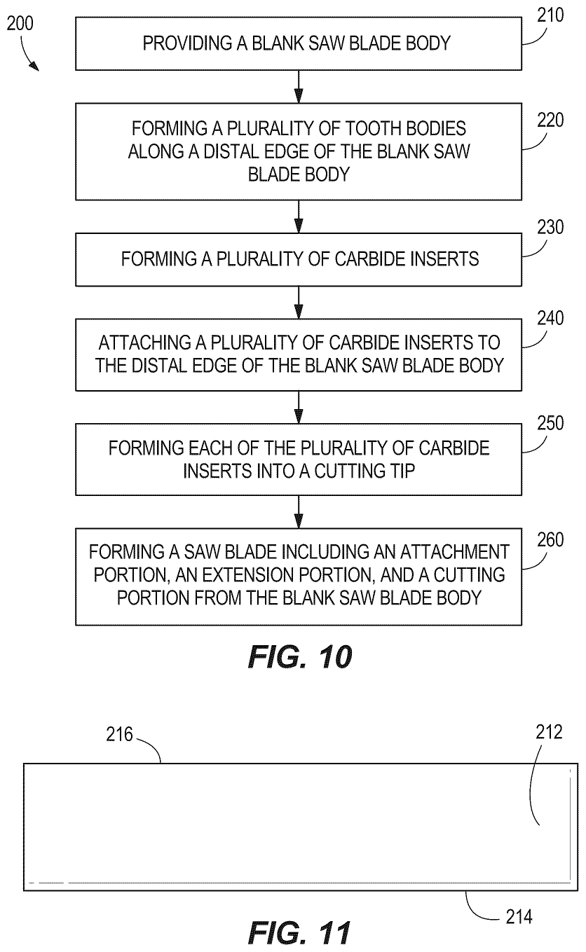

With reference to FIG. 10, a method 200 of manufacturing the blade 44 is illustrated. For the sake of brevity, the method is described with respect to the blade 44 of FIGS. 3 and 4 having the curved distal edge 70a. However, it is understood that the method for manufacturing the blade 144 of FIGS. 7 and 8 having the linear distal edge 170a may be substantially similar as the method 200. In addition, although the method 200 includes particular steps in a particular order, not all of the steps need to be performed or need to be performed in the order presented.

At step 210, with reference to FIGS. 10 and 11 the method 200 includes providing a blank saw blade body 212. The blank saw blade body 212 may be provided as a piece of sheet metal having the thickness T1 (FIG. 4). The metal may be, for example, hardened steel, spring steel, D6A, any type of steel, or any other suitable metal. The blank saw blade body 212 may have varying sizes dependent on how many blades 44 a user wishes to yield from the manufacturing process. The blank saw blade body 212 includes a proximal edge 214 that will eventually form the proximal edge 62a of each distinct blade 44 (FIG. 3) that is formed from the blank saw blade body 212 and a distal edge 216 that will eventually form the distal edge 70a of each distinct blade 44 (FIG. 3) formed from the blank saw blade body 212.

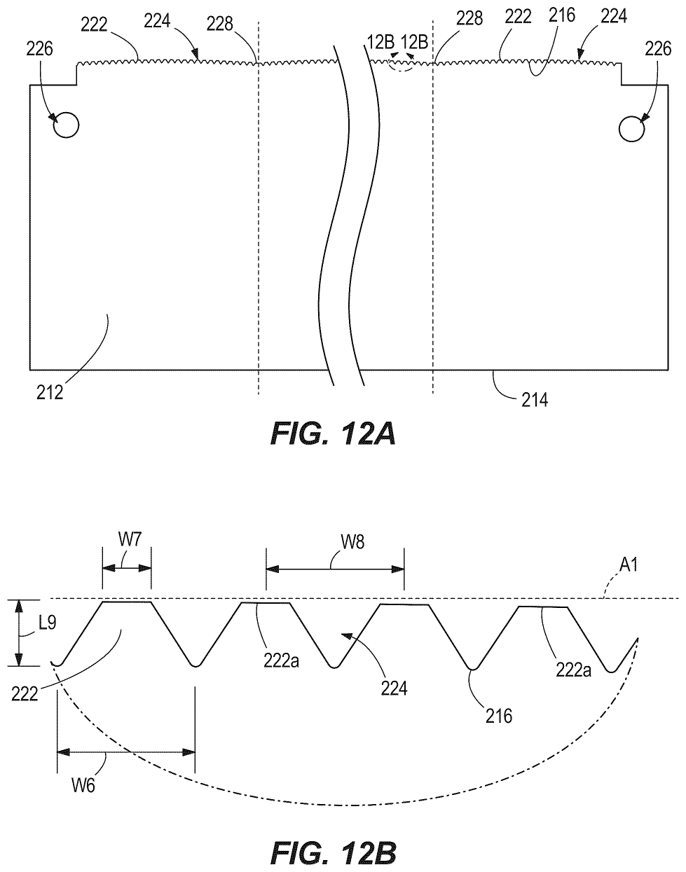

At step 220, with reference to FIGS. 10, 12A, and 12B, the method 200 includes forming a plurality of tooth bodies 222 along the distal edge 216 of the saw blade body 212. In the illustrated embodiment, the plurality of tooth bodies 222 is formed through a laser blanking process in which the tooth bodies 222 are uniformly formed along the distal edge 216 of the saw blade body 212 with gullets 224 therebetween. In other words, each of the tooth bodies 222 is formed equally spaced from adjacent tooth bodies 222 with a gullet 224 between each of the tooth bodies 222. The tooth bodies 222 are formed with a trapezoidal shape in which a base and a top 222a of the tooth bodies 222 extends parallel to each other. The trapezoidal shape of each tooth body 222 is dependent upon a tooth body height measured between the base and the top 222a, a tooth body width measured along a width direction as described with respect to FIG. 3, the size of the gullets 224, and a tooth body volume. In some embodiments, the plurality of tooth bodies 222 may be non-uniformly formed. In other embodiments, the method 200 may not include forming the plurality of tooth bodies 222. Rather, for example, the method 200 may include forming recesses or pockets in the distal edge 216 of the blank saw blade body 212. The pockets may be formed with the same radius of curvature as the carbide inserts 80 of FIG. 6 for receiving the carbide inserts 80. Step 220 may also include forming mounting apertures 226 in the blank saw blade body 212 for mounting the blank saw blade body 212 to a resistance welder after the tooth bodies 222 have been formed.

In the illustrated embodiment of FIGS. 12A and 12B, the laser blanking process includes forming the tooth bodies 222 sequentially along a curvature (e.g., along the radius of curvature R1 illustrated in FIG. 3). A reference axis A1 that extends along a width direction, as described with respect to FIG. 3, is illustrated in FIG. 12B. Due to the formation of the tooth bodies 222 along the curvature, tops 222a of the tooth bodies 222 are spaced different distances from the reference axis A1 than the tops 222a of the other tooth bodies 222. For example, the top 222a of one of the tooth bodies 222 may extend parallel to and co-planar with the reference axis A1 while the top 222a of another of the tooth bodies 222 may extend at an angle relative to and be offset from the reference axis A1. In implementations in which it is desired to yield multiple blades 44 (FIG. 3) from the method 200, the laser blanking process at step 220 includes forming multiple distinct curved segments which are separated by a gap tooth 228 that signifies the end of one segment and the beginning of the next segment. By forming the gap tooth 228 to separate the curved segments, the user is able to form multiple blades 44 having the same radius of curvature as one another (e.g., the radius R1 of FIG. 3).

With continued reference to FIGS. 12A and 12B, each of the tooth bodies 222 is formed with a first length L9, a first width W6, a second width W7, and a third width W8. The first length L9 may be measured between the distal edge 216 of the blank saw blade body 212 and the top 222a of the tooth body 222. The first length L9 may be between about 0.01 inches and about 0.05 inches. More specifically, the first length L9 is between about 0.02 inches and about 0.03 inches, and even more specifically, the first length L9 is about 0.024 inches. The first width W6 may be measured between ends of the tooth body 222 at the base of the tooth body 222 (e.g., at the distal edge 216 of the blank saw blade body 212). The first width W6 may be between about 0.02 inches and about 0.08 inches. More specifically, the first width W6 may be between about 0.045 inches and about 0.055 inches, and even more specifically, the first width W6 is about 0.051 inches. The second width W7 may be measured between ends of the tooth body 222 at the top 222a of the tooth body 222. The second width W7 may be between about 0.005 inches and about 0.03 inches. More specifically, the second width W7 may be between about 0.015 inches and about 0.02 inches, and even more specifically, the second width W7 is about 0.018 inches. The third width W8 is the distance between tooth bodies 222 and may also be referred to as the pitch. The third width W8 may, for example, be measured from the center of one tooth body 222 to the center of an adjacent tooth body 222. The third width W8 may be between about 0.02 inches and about 0.08 inches. More specifically, the third width W8 may be between about 0.045 inches and about 0.055 inches, and even more specifically, the third width W8 is about 0.051 inches. “About” means within a tolerance of +/−0.005 inches for the first length L9, the first width W6, and the second width W7 of the tooth bodies 222.

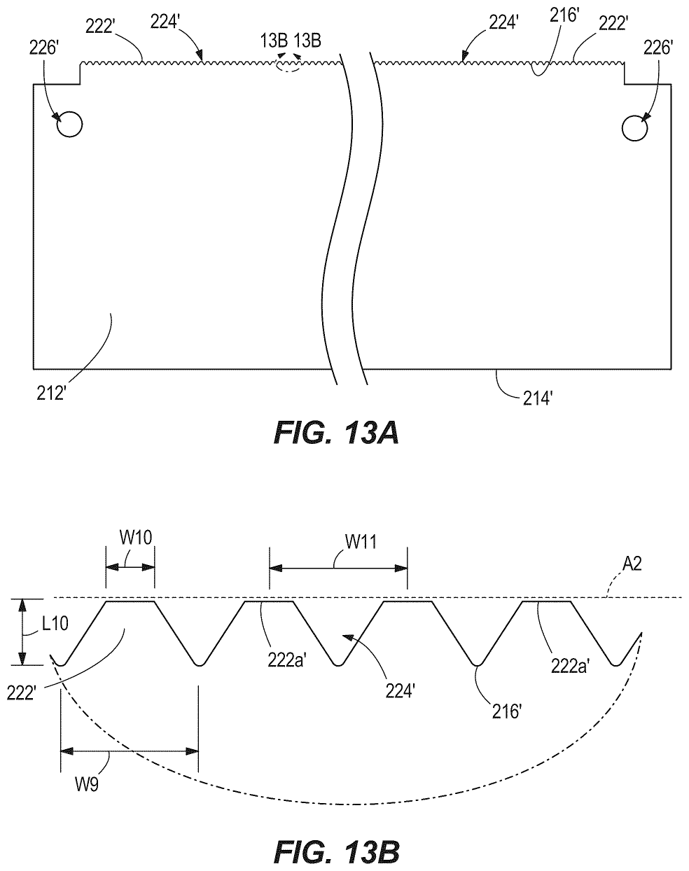

As illustrated in FIGS. 13A and 13B, for embodiments of the method 200 utilized to form a blade 144 with a linear distal edge 170a (FIG. 7), the laser blanking process includes forming tooth bodies 222′ sequentially along a distal edge 216′ of a blank saw blade body 212′ in a linear fashion. The laser blanking process may also include forming a proximal edge 214′, gullets 224′ between adjacent tooth bodies 222′, and mounting apertures 226′. A reference axis A2 that extends along a width direction, as described with respect to FIG. 3, is illustrated in FIG. 13B. Due to the formation of the tooth bodies 222′ in a linear fashion, a top 222a′ of each the tooth bodies 222′ extends parallel to and co-planar with the reference axis A2.

With continued reference to FIGS. 13A and 13B, each of the tooth bodies 222′ is formed with a first length L10, a first width W9, a second width W10, and a third width W11. The first length L10 may be measured between the distal edge 216′ of the blank saw blade body 212′ and the top 222a′ of the tooth body 222′. The first length L10 of the tooth bodies 222′ of FIGS. 13A and 13B may be substantially similar to the first length L9 of the tooth bodies 222 of FIGS. 12A and 12B. The first width W9 may be measured between ends of the tooth body 222′ at the base of the tooth body 222′ (e.g., at the distal edge 216′ of the blank saw blade body 212′). The first width W9 of the tooth bodies 222′ of FIGS. 13A and 13B may be substantially similar to the first width W6 of the tooth bodies 222 of FIGS. 12A and 12B. The second width W10 may be measured between ends of the tooth body 222 at the top 222a of the tooth body 222. The second width W10 of the tooth bodies 222′ of FIGS. 13A and 13B may be substantially similar to the second width W7 of the tooth bodies 222 of FIGS. 12A and 12B. The third width W11 is the distance between tooth bodies 222′ and may also be referred to as the pitch. The third width W11 may, for example, be measured from the center of one tooth body 222′ to the center of an adjacent tooth body 222′. The third width W11 of the tooth bodies 222′ of FIGS. 13A and 13B may be substantially similar to the third width W11 of the tooth bodies 222 of FIGS. 12A and 12B. “Substantially similar” means within a tolerance of +/−0.002 inches for the first length L10, the first width W9, the second width W10, and the third width W11 (relative to a respective one of the first length L10, the first width W6, the second width W7, and the third width W8 of FIGS. 12A and 12B).

At step 230, with reference to FIGS. 6 and 10, the method 200 includes forming a plurality of carbide inserts 80. In the illustrated embodiment, the plurality of carbide inserts 80 is formed from a cylindrical blank 98. Specifically, the carbide inserts 80 may be cut from the cylindrical blank 98 into circular discs having the same thickness T2 as the blank saw blade body 212 (i.e., the thickness T1). In some embodiments, the carbide inserts 80 may be formed with a smaller or larger thickness than the thickness T1 of the blank saw blade body 212. In other embodiments, the carbide inserts 80 may be formed in other shapes, such as a rectangular prism. The carbide inserts 80 may be formed through a process such as laser cutting.

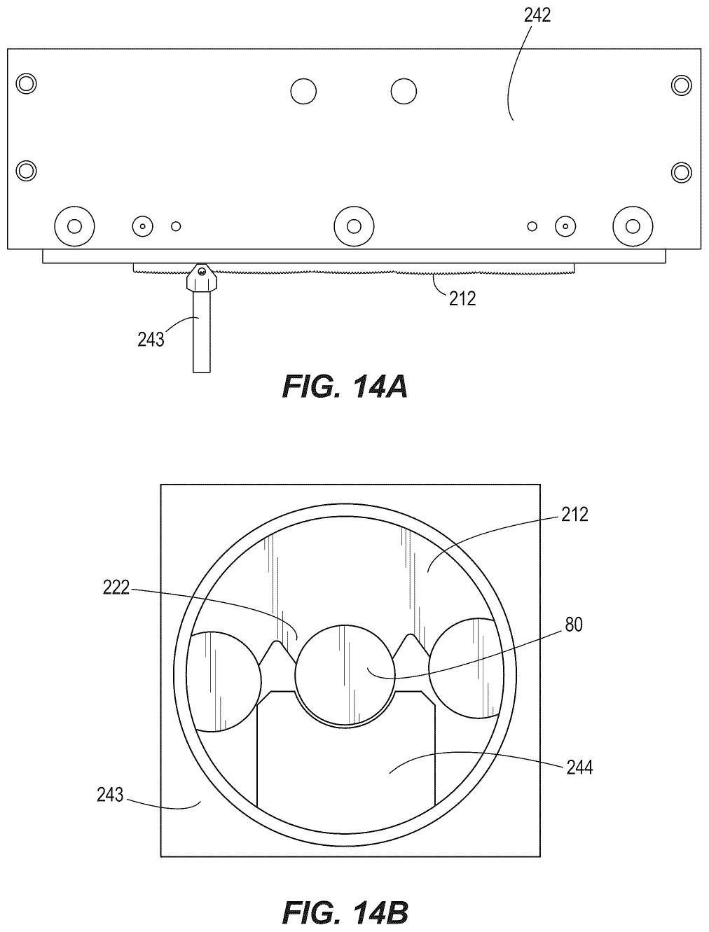

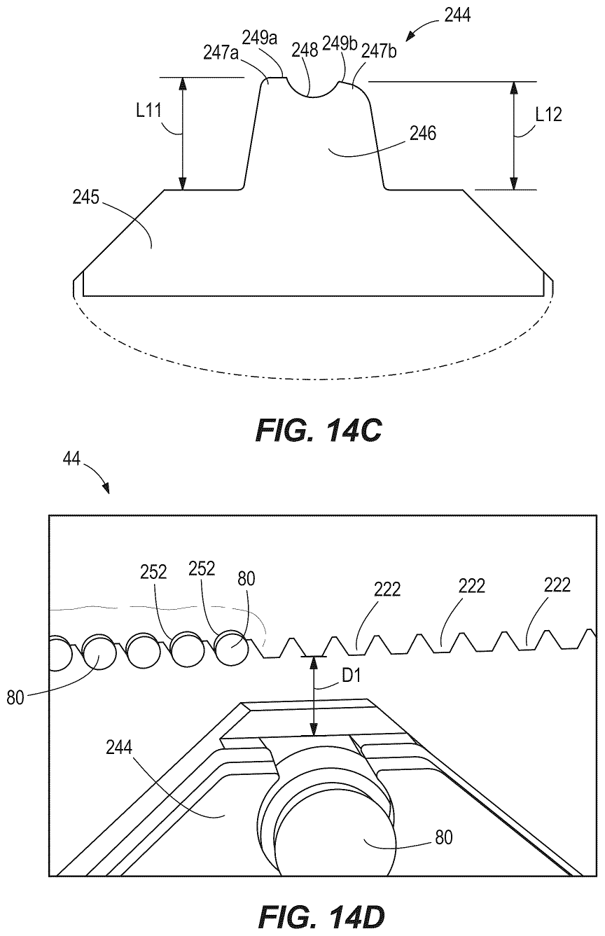

At step 240, with reference to FIGS. 10, 14A, and 14B, the method 200 includes attaching (e.g., resistance welding) the plurality of carbide inserts 80 to the distal edge 216 of the blank saw blade body 212. Specifically, step 240 includes attaching one of the plurality of carbide inserts 80 to each of the plurality of tooth bodies 222. In the illustrated embodiment, the carbide inserts 80 are attached to the tooth bodies 222 through resistance welding. Resistance welding includes heating the tooth bodies 222 and the carbide inserts 80 with an electric current to melt a desired point of contact for each respective tooth body 222 and carbide insert 80. The tooth bodies 222 and the inserts 80 may then be placed in contact with each other and allowed to harden to join the inserts 80 to the tooth bodies 222. In the illustrated embodiment, the blank saw blade body 212 is attached to a resistance welding machine 242 (e.g., the mounting apertures 226) that is configured to provide an electric current through the blank saw blade body 212 to heat and melt the contact point of each tooth body 222. The carbide inserts 80 may then be brought into contact with the tooth bodies 222 via a movable machine 243 including an electrode 244 that is configured to provide electric current through the carbide insert 80 to heat and melt the contact point of the carbide insert 80.

As electric current is provided through the carbide inserts 80 and the blank saw blade body 212, each tooth body 222 creates a weld pool 252 (FIG. 14D) proximate the contact point of the tooth body 222 and the contact point of the carbide insert 80. To effectively control weld pool development and ensure that developing weld pools do not influence adjacent weld locations, timing and amperage for the welding process is refined to particular parameters. More specifically, low amperage is utilized for a lengthy time to avoid using excessive amperage for short durations. Therefore, when the carbide inserts 80 are welded to the tooth bodies 222, the desired point of contact for each respective tooth body 222 and carbide insert 80 is gradually melted to produce a strong and consistent weld quality.

In addition, the trapezoidal shape of the tooth bodies 222 helps with controlling weld pool development given that the tooth bodies 222 are close together due to the high TPI of the blade 44. The particular geometry of the tooth bodies 222 reduces or inhibits overlap of the weld pools, manages heat distribution, and ensures that each carbide insert 80 is uniformly and securely attached to the blank saw blade body 212. The trapezoidal shape of the tooth bodies 222 also influences weld strength and produces consistent weld formations.

With reference to FIG. 14C, the electrode 244 is illustrated in more detail. The electrode 244 includes a base 245 and a body 246 coupled to the base 245. In the illustrated embodiment, the base 245 and the body 246 are integrally formed together. In other embodiments, the base 245 and the body 246 may be separate parts coupled together by various coupling methods. The body 246 of the electrode 244 has a first arm 247a and a second arm 247b extending therefrom in a direction opposite the base 245. Also, a groove 248 is defined within the body 246 of the electrode 244 between the first and second arms 247a, 247b. The groove 248 is configured to receive the carbide insert 80 and retain the carbide insert 80 between the first and second arms 247a, 247b for movement with the movable machine 243.

The first arm 247a has a first arm length L11 defined between the base 245 and an apex or tip 249a of the first arm 247a. The first arm length L11 may be between about 0.082 inches and about 0.084 inches. In the illustrated embodiment, the first arm length L11 is about 0.083 inches. The second arm 247b has a second arm length L12 defined between the base 245 and an apex or tip 249b of the second arm 247b. The second arm length L12 may be between about 0.079 inches and about 0.081 inches. In the illustrated embodiment, the second arm length L12 is about 0.080 inches. As such, the first arm length L11 is greater than the second arm length L12 such that the electrode 244 includes a long arm 247a and a short arm 247b.

When resistance welding the carbide inserts 80 to the tooth bodies 222, the electrode 244 is oriented relative to the blank saw blade body 212 such that the second (i.e., short) arm 247b is adjacent a previously attached carbide insert 80. The placement of the short arm 247b allows the electrode 244 to avoid interacting with an adjacent weld pool. Achieving minimal interference of the electrode 244 with adjacent weld pools facilitates dealing with a complex welding process. The complex welding process is a result of the high TPI of the blade 44 producing close carbide inserts 80, and in turn, overlapping heat zones. Also, minimal interference with adjacent weld pools increases a lifetime of the electrode 244.

FIG. 14D illustrates one of the carbide inserts 80 disposed on the electrode 244 ready for attachment to the saw blade body 212 during step 240. With respect to the blade 44 of FIGS. 3 and 4 having the curved distal edge 70a, one of the carbide inserts 80 may be moved towards the distal edge 216 of the saw blade body 212 in a first direction perpendicular to the reference axis A1 of FIG. 12B via the movable machine 243. Another one of the carbide inserts 80 may be moved towards the distal edge 216 in a second direction oriented one or two degree less than 90 degrees relative to the reference axis A1 via the movable machine 243. Although, to the naked eye it may appear that the carbide inserts 80 are moved towards the distal edge 216 in a direction D1 generally perpendicular to the reference axis A1. With respect to the blade 144 of FIGS. 7 and 8 having the linear distal edge 170a, the carbide inserts 80 may also move in the direction D1 generally perpendicular to the reference axis A2 of FIG. 13B. As such, the carbide inserts 80 are welded to the saw blade bodies 212, 212′ perpendicular to a corresponding references axis A1, A2 resulting in symmetric and fully wetted joints for bi-directional cutting operations.

In the illustrated embodiment, the carbide inserts 80 are discretely attached to a corresponding tooth body 222 one at a time due to the small distance between the tooth bodies 222 in order to form the blade 44 (FIG. 3) with a high TPI such as 18 TPI or at least 15 TPI. After each carbide insert 80 is welded to the corresponding tooth body 222, the movable machine 243 may be separated from the blank saw blade body 212 and allow a user to place a new carbide insert 80 onto the electrode 244 for adjoining the carbide insert 80 to the next tooth body 222.

The speed in which the carbide inserts 80 are welded to the tooth bodies 222 is slowed down to handle heat buildup that may affect weld strength. In particular, the accumulation of heat is managed by introducing a delay between consecutive welding operations. A welding operation specifically involves moving the movable machine 243 toward the saw blade body 212 until the carbide insert 80 contacts a corresponding tooth body 222, welding the carbide insert 80 to the corresponding tooth body 222, and then separating the movable machine 243 from the blank saw blade body 212 until the movable machine 243 is spaced an adequate distance from the blank saw blade body 212 for placing another carbide insert 80 onto the electrode 244.

After one of the carbide inserts 80 is welded to the blank saw blade body 212 to complete one welding operation, the step 240 may be delayed for a predetermined time period. In some embodiments, the predetermined time period may be at least one second. In other embodiments, the predetermined time period may be between 0.5 and 2 seconds. In preferred embodiments, the predetermined time period may be between 0.6 and 1.5 seconds. After the predetermined time period has past, the step 240 may resume so that another one of the carbide inserts 80 may be welded to the blank saw blade body 212 to complete another welding operation. As such, the predetermined time period provides a relatively long pause between consecutive welding operations to produce a strong bond between the carbide inserts 80 and the blank saw blade body 212 in comparison to other welding processes with shorter pauses which increase internal stresses of weld joints and produce weaker bonds.

At step 250, with reference to FIGS. 5B and 10, the method 200 includes forming each of the plurality of carbide inserts 80 into a cutting tip 78. In the illustrated embodiment, the cutting tips 78 are formed through machining (e.g., grinding, cutting, or any other suitable machine technique or combination thereof) the carbide insert 80 after the carbide insert 80 has been attached to the tooth body. In further embodiments, at step 250, the method 200 may include heat treating (e.g., tempering) the cutting tips 78 to relieve welding stresses and increase durability of the blade 44. Specifically, the carbide inserts 80 are machined to include the curved edge 82, the straight edges 86a, 86b, and the tip 90. Each carbide insert 80 is also machined to have a height (e.g., the first length L5 of the cutting tips 78) that positively influences the cutting performance of the blade 44. In some embodiments, the carbide inserts 80 may be machined into the cutting tip 78 prior to attaching the carbide insert 80 to the tooth body 222. In other embodiments, the carbide inserts 80 may be cut into the shape of the cutting tips 78 directly from a blank. Each cutting tip 78 is discretely machined one at a time. However, in other embodiments, multiple cutting tips 78 may be machined at once. In some embodiments, forming each of the plurality of carbide inserts 80 into a cutting tip 78 at step 250 may include machining the tooth bodies 222 of FIG. 12B to increase a size of the gullets 224 or the tooth bodies 222′ of FIG. 13B to increase a size of the gullets 224′. In additional embodiments, the cutting tips 78 may be edge-prepped to remove sharp edges by forming chamfered or curved edges, and thereby increase fracture toughness and the lifetime of the blade 44 by at least two times.

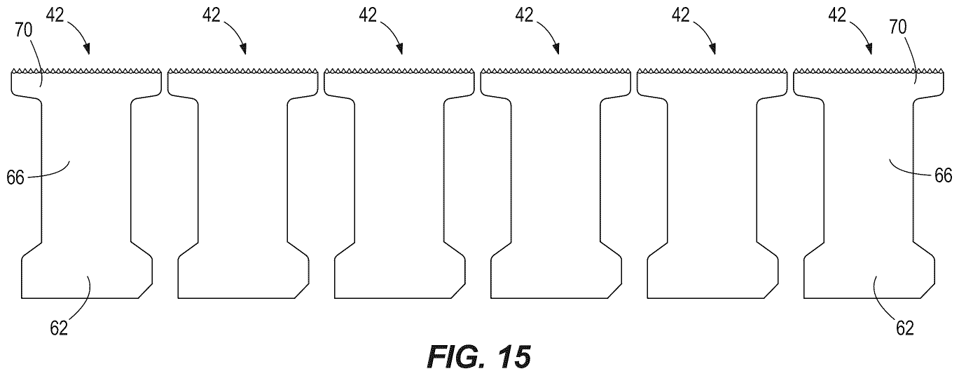

At step 260, with reference to FIGS. 3, 10, and 15, the method 200 includes forming a blade 42 including an attachment portion 62, an extension portion 66, and a cutting portion 70 from the blank saw blade body 212. In the illustrated embodiment, the blade 42 is formed by laser cutting the attachment portion 62, the extension portion 66, and the cutting portion 70 into the blank saw blade body 212 (FIG. 12A). Each of the attachment portion 62, the extension portion 66, and the cutting portion 70 have the same size and shape as the attachment portion 62, the extension portion 66, and the cutting portion 70 described herein (e.g., with respect to FIGS. 3 and 4). The blank saw blade body 212 (FIG. 12A) may have a size that permits a user to form multiple blades 42 from a single manufacturing process at the step 260. Accordingly, the method 200 allows a user to efficiently manufacture multiple blades 42 from a single process, thereby reducing manufacturing costs.

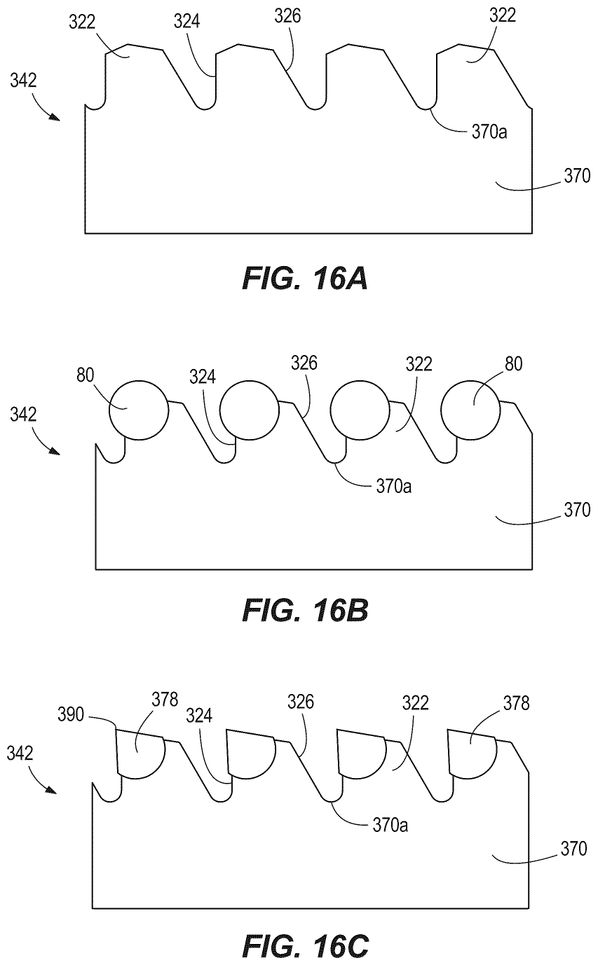

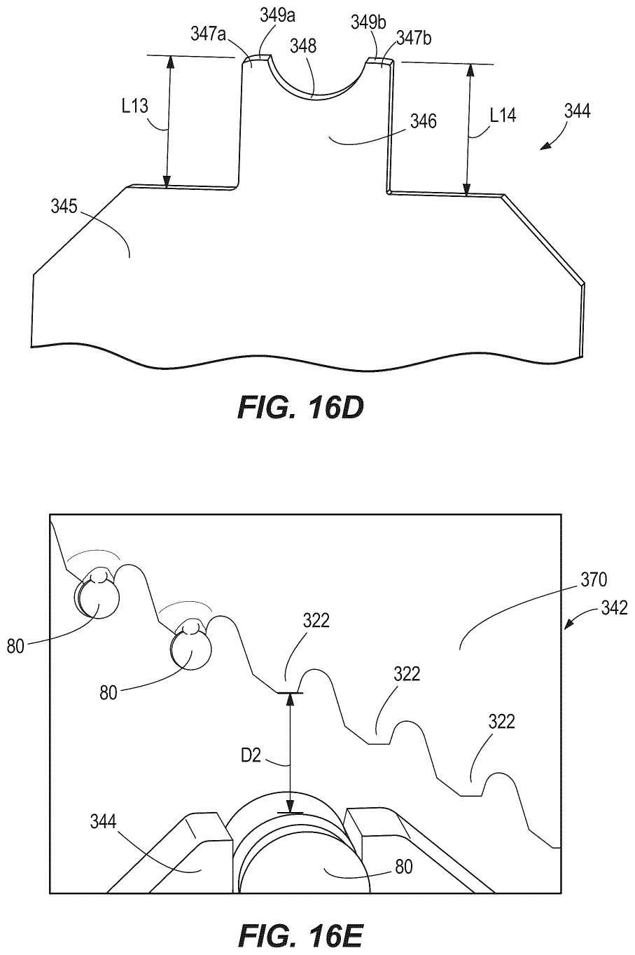

FIGS. 16A-16C illustrate a conventional reciprocating saw blade 342 including a cutting portion 370 with a distal edge 370a. In the illustrated embodiment, the distal edge 370a is linear. However, the distal edge 370a may alternatively be curved. With reference to FIGS. 10 and 16A, at step 220, the blade 342 may be formed with tooth bodies 322 along the distal edge 370a having a forward face 324 that extends parallel to a length direction (e.g., the length direction described with respect to FIG. 3) and a rearward face 326 that extends transverse to both the length direction and a width direction (e.g., the width direction described with respect to FIG. 3).

With reference to FIGS. 10, 16B, and 16D, at step 240, carbide inserts 80 may be attached or resistance welded to the tooth bodies 322 at the top of the forward face 324 of the tooth bodies 322 to form the blade 342 with a low TPI. In some embodiments, the blade 342 may have between 5 and 10 TPI. In preferred embodiments, the blade 342 may have between 6 and 9.1 TPI.

Specifically, step 240 may include attaching the carbide inserts 80 to the tooth bodies 322 through resistance welding. The carbide inserts 80 may be brought into contact with the tooth bodies 322 via a movable machine (e.g., movable machine 243) including an electrode 344 (FIG. 16D) configured to provide electric current through the carbide insert 80 to heat and melt the contact point of the carbide insert 80. The electrode 344 has a base 345, a body 346, a first arm 347a, and a second arm 347b. A groove 348 is defined on the body 346 of the electrode 344 and extends between the first and second arms 347a, 347b for receiving a carbide insert 80 having a diameter that may be between about 0.052 inches and about 0.063 inches. The first arm 347a has a first arm length L13 and the second arm 347b has a second arm length L14. The first arm length L13 is defined between the base 345 and an apex or tip 349a of the first arm 347a. The second arm length L14 is defined between the base 345 and an apex or tip 349b of the second arm 347b. Unlike the electrode 244 of FIG. 14C, the first and second arm lengths L13, L14 are substantially equal, and thereby provide a conventional electrode 344 used for manufacturing the conventional reciprocating saw blade 342.

Since wider spacing is defined between the tooth bodies 322, in comparison to the blades 44, 144 of FIGS. 3 and 7, occurrences in which the electrode 344 may interfere with adjacent weld pools is minimal. As such, it is acceptable for the first arm 247a and the second arm 247b to be the same length. Controlling the development of weld pools is also easier to manage, in comparison to the blades 44, 144 of FIGS. 3 and 7, due to the teeth spacing of the low TPI blade 342 ultimately producing no overlapping heat zones. Lastly, heat buildup is less likely to accumulate on account of the low TPI, and thereby allow a faster welding process in which a relatively short pause between consecutive welding operations is performed.

FIG. 16E illustrates one of the carbide inserts 80 disposed on the electrode 344 for attachment to the tooth bodies 322. As such, the step 240 may also include moving the carbide inserts 80 towards the distal edge 370a in a direction D2 obliquely oriented relative to the width direction. The carbide inserts 80 are then welded to the tooth bodies 322 at an oblique angle relative to the width direction resulting in an asymmetric tooth geometry for aggressive and unidirectional cutting operations.

Then at step 250, with reference to FIGS. 10 and 16C, the carbide inserts 80 may be machined into cutting tips 378 having a tip 390. As illustrated in FIG. 16C, the tip 390 of each of the cutting tips 378 is oriented at an angle which may alter the type of cut that the blade 342 is configured to make during a cutting action. It is understood that the cutting tips 78, 178, 378 may be formed in any orientation according to a preferable type of cut for the blades 44, 144, 342.

Although the disclosure has been described in detail with reference to certain preferred implementations, variations and modifications exist within the scope and spirit of one or more independent aspects of the disclosure as described.

Various features of the disclosure are set forth in the following claims.

1. A blade comprising:
a body including a cutting portion having
an edge, and
a plurality of cutting teeth sequentially aligned along the edge, each cutting tooth of the plurality of cutting teeth being formed from a corresponding one of a plurality of carbide inserts that is discretely resistance welded to the edge,
wherein the body includes at least 15 teeth per inch.

2. The blade of claim 1, wherein the edge has a radius of curvature, and wherein the plurality of cutting teeth is sequentially aligned on the edge along the radius of curvature.

3. The blade of claim 1, wherein the body has a maximum width, and wherein the edge extends parallel to a direction defined by the maximum width.

4. The blade of claim 1, wherein each cutting tooth of the cutting teeth includes a first straight edge and a second straight edge that meet at a tip of the cutting tooth, and wherein the first straight edge and the second straight edge define an angle with respect to each other that is between 30 and 85 degrees.

5. The blade of claim 1, wherein the plurality of cutting teeth have a different shape than the carbide inserts.

6. The blade of claim 1, wherein each cutting tooth of the plurality of cutting teeth has a length defined between the edge of the body and a tip of the cutting tooth, and wherein the length is between about 0.02 inches and about 0.04 inches.

7. A method of manufacturing a blade, the method comprising:
providing a blank saw blade body that includes a proximal edge that is configured for attachment to a power tool and a distal edge opposite from the proximal edge;
resistance welding a plurality of carbide inserts to the distal edge of the blank saw blade body; and
forming each of the carbide inserts into a cutting tooth after the plurality of carbide inserts have been resistance welded to the distal edge of the blank saw blade body such that the blank saw blade body has at least 15 teeth per inch.

8. The method of claim 7, wherein each carbide insert has a first shape and each cutting tooth has a second shape.

9. The method of claim 8, wherein resistance welding the plurality of carbide inserts includes resistance welding the plurality of carbide inserts having the first shape to the distal edge of the blank saw blade body through resistance welding.

10. The method of claim 8, wherein the first shape is circular, and wherein the second shape includes a tip configured to perform a cutting action.

11. The method of claim 7, wherein resistance welding the plurality of carbide inserts includes utilizing an electrode for resistance welding each carbide insert to the distal edge.

12. The method of claim 11, wherein the electrode includes a base and a body coupled to the base, and wherein the body has a first arm, a second arm, and a groove defined therebetween and configured to receive each carbide insert.

13. The method of claim 12, wherein the first arm has a first length defined between a first apex of the first arm and the base and the second arm has a second length defined between a second apex of the second arm and the base, and wherein the first length is greater than the second length.

14. The method of claim 13, wherein resistance welding the plurality of carbide inserts includes bringing each carbide insert into contact with the distal edge such that the second arm is adjacent one of the plurality of carbide inserts previously welded to the distal edge.

15. The method of claim 7, further comprising:
prior to resistance welding the plurality of carbide inserts, moving each carbide insert towards the distal edge in a direction perpendicular to an axis extending along a width direction.

16. The method of claim 7, further comprising:
after providing the blank saw blade body, forming a plurality of tooth bodies along the distal edge of the blank saw blade body such that each tooth body is formed with a trapezoidal shape.

17. The method of claim 16, wherein resistance welding the plurality of carbide inserts includes resistance welding one of the plurality of carbide inserts to each tooth body.

18. The method of claim 7, wherein resistance welding the plurality of carbide inserts includes:
resistance welding a first carbide insert of the carbide inserts to the distal edge of the blank saw blade body,
delaying the resistance welding of the plurality of carbide inserts to the distal edge of the blank saw blade body for a predetermined time period, and
resuming the resistance welding of the plurality of carbide inserts to the distal edge of the blank saw blade body after the predetermined time period such that a second carbide insert of the carbide inserts is resistance welded to the distal edge.

19. The method of claim 18, wherein the predetermined time period is at least one second.

20. The method of claim 18, wherein the predetermined time period is between 0.6 and 1.5 seconds.

21. The method of claim 7, further comprising:
prior to resistance welding the plurality of carbide inserts, forming the plurality of carbide inserts from a cylindrical blank.

22. The method of claim 7, wherein forming each of the carbide inserts into a cutting tooth includes forming each cutting tooth to have a length defined between the distal edge of the blank saw blade body and a tip of each cutting tooth, and wherein the length is between about 0.02 inches and about 0.04 inches.

23. The method of claim 7, further comprising tempering the blade after resistance welding the plurality of carbide inserts to the distal edge of the blank saw blade body.

24. The method of claim 7, further comprising edge prepping the plurality of carbide inserts after the forming each of the carbide inserts into a cutting tooth.
